(19) United States
(12) Patent Application Publication
(10) Pub. No.: US 2005/0146603 A1
(43) Pub. Date: Jul. 7, 2005

(54) Electronic rear viewing means for motor vehicles

(76) Inventors: Federico Cellina, Milano (IT); Marcella Forlani, Milano (IT)

Correspondence Address: Striker Striker & Stenby, 103 East Neck Road, Huntington, NY, 11743, US

(21) Appl. No.: 10/503,862

(22) PCT Filed: May 6, 2002
(86) PCT No.: PCT/IT02/00295

(30) Foreign Application Priority Data
Apr. 26, 2002 (IT) MI2002A000904

(51) Int. Cl. H04N 7/00; H04N 7/18; H04N 9/47

(52) U.S. Cl. 348/118

(57) ABSTRACT

Apparatus (25, 30-33) for electronic rearward vision in motor vehicles (10) comprising a kinescope (25) placed centrally on the instrument panel (11) and the device with iconoscope (30-33) placed at the sides of the vehicle (10) and facing towards the rear, shaped and situated so as substantially to constitute lateral and rear “eyes” for the driver (50), whereby forward and reversing movements, especially when parking, are facilitated in that use of the kinescope (25) obviates any need to turn head and shoulders in order to observe available space around the vehicle (10) and to be aware of changes in such space caused by movement of the driver's own vehicle and by others.

The invention concerns means applied to motor vehicles for rearward viewing.

Those at present used in motor vehicles for rearward and lateral viewing, especially when reversing or parking, are known to consist of mirrors mechanically fitted inside the vehicle above the windshield as well as latterally on the outside near the front windows and, recently, of a telecamera placed centrally low down at the rear as a further aid to parking.

Safety while driving in fact depends not only on what the driver can see in front of the vehicle but also at the sides and back.

To avoid accidents a driver must be aware not only of his or her own vehicle's movement but also of those of other vehicles around it.

Up to the time when motor vehicles still moved at moderate speeds and as long as electronic means were not only costly but unreliable, it was obviously unthinkable to use them for lateral and rear viewing even though mechanically fixed driving mirrors have long proved inadequate for ensuring easy, effective and constant vision.

Considering the present-day widespread use of electronics at greatly lowered costs, as well as travelling speeds and the chaotic conditions of traffic, the present invention offers an effective application of electronics to provide all-round vision for drivers.

By the means here described a driver is constantly aware of available space around his vehicle and of the movements of other vehicles in any direction, as will now be explained.

Subject of the invention is an electronic apparatus for rearward vision.

The apparatus comprises a kinescope and devices, each with an iconoscope, facing towards the rear of the vehicle, shaped and situated to provide “eyes” for the driver at the sides and back.

During forward movement the driver can see not only in front but also evaluate the changing amount of available space on each side and behind the vehicle without turning his head, especially useful when parking.

The devices with iconoscope, can be placed at the sides and towards the rear of the vehicle, as well as at the rear itself and, according to need, can consist of one per side, or four at different levels on the sides and at the back.

Each device comprises an objective, an iconoscope and the electronics for converting the beam into electric signals.

The objective is preferably wind-angled.

The kinescope, with electronics for converting electric signals to images, as well as the components of the device with iconoscope, such as those for power feed, are situated on the instrument panel.

The kinoscope is preferably in a central position, partially extending to the base of the windshield, but keeping in line with the top of the bonnet to avoid interference with the driver's optic cone projecting in front of the vehicle.

The devices, each with an iconoscope, are situated so as to provide the electronics of the kinescope with an overall view of space around the vehicle.

The electronics in the kinoscope, for reconverting signals from the devices with iconoscope, comprise a process control computer to obtain an overall view of the surrounding area, correcting any superimposition, interference and other irregularities, as well as deflection of images due to the kinoscope facing the same way as the objective.

The devices with iconoscope are preferably protectively housed in recesses each with a door flap.

When the engine is switched on, motor-driven means automatically open the door flaps and the objective in the devices with iconoscope assumes the best operative position.

The kinescope can advantageously be used for a system of navigation by satellite and for other indications useful to the driver.

The invention offers evident advantages.

An apparatus, replacing the present type of driving mirror, supplies the driver with electronic “eyes” to see all round, an immensely important advantage on the roads of today crammed as they are with vehicles all travelling at different speeds, overtaking or coming up alongside.

For the first time a driver can keep a check not only on what he sees in front, but on each side and behind his vehicle as well.

Backing the vehicle, so problematic with present-day means, is greatly eased, full vision being provided not only of available space low down, but also of that high up, highly useful when having to back into a narrow entrance.

Yet another advantage is thus offered to the many drivers who are unable to turn their heads a full 180°.

Such an invented apparatus can help to reduce the harm done to people, to animals and to property so frequent throughout the world.

Use of the kinoscope for satellite navigation greatly increases the advantages gained in relation to costs.

Characteristics and purposes of the disclosure will be made still clearer from the following example of its use illustrated by diagrammatically drawn figures.

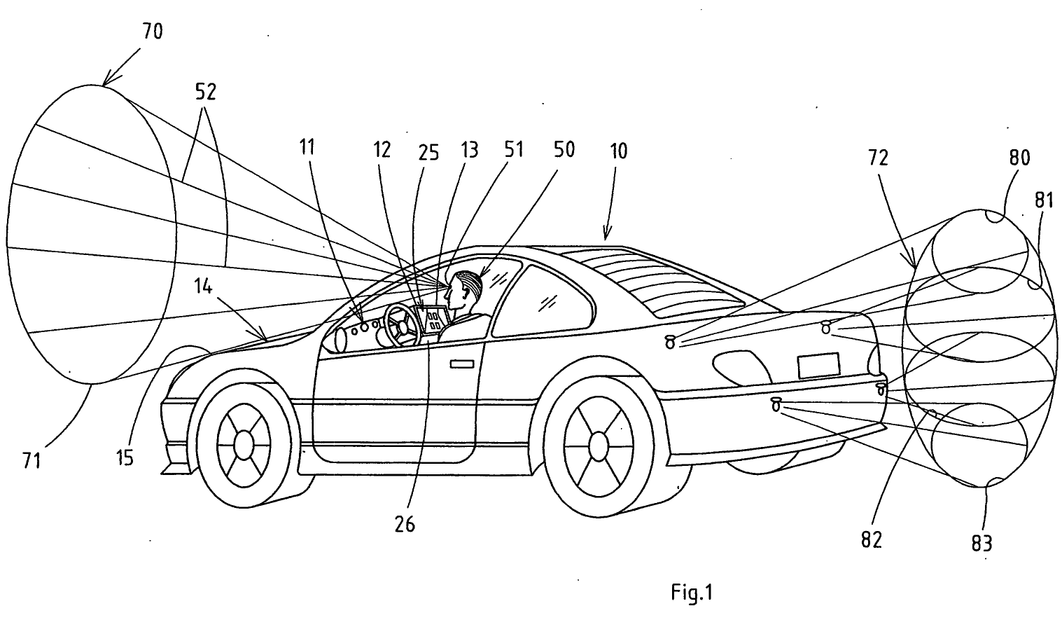

FIG. 1 Motor vehicle showing application of the electronic rear-view apparatus and of the device with iconoscope when in use, a rear perspective.

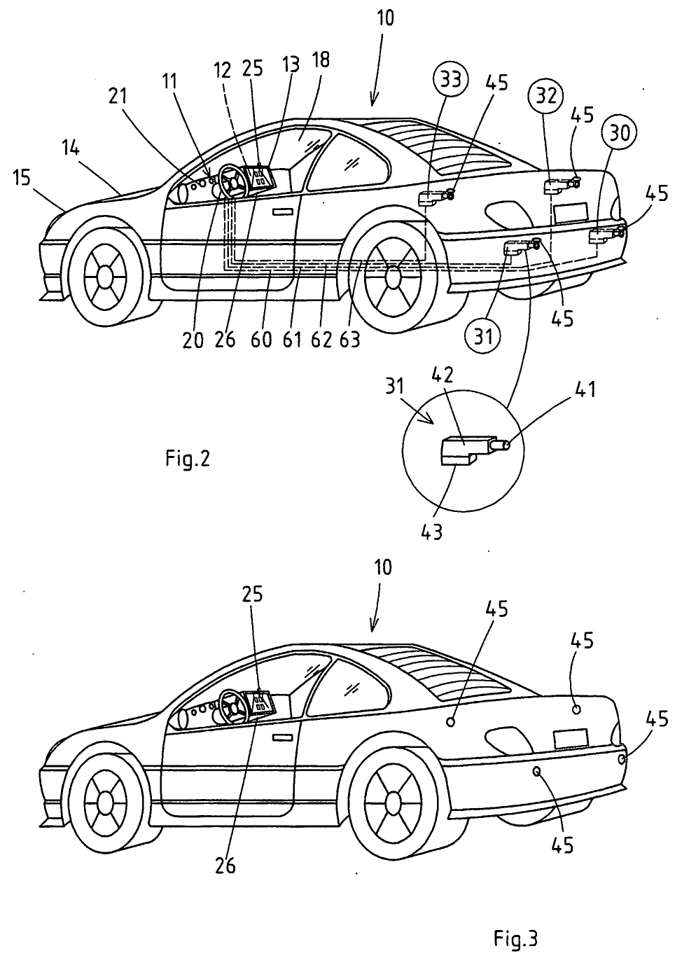

FIG. 2 As above, internal parts and detail of a device with iconoscope.

FIG. 3 As above, when the devices with iconoscope are idle, inside housings closed by door-flaps, a rear perspective.

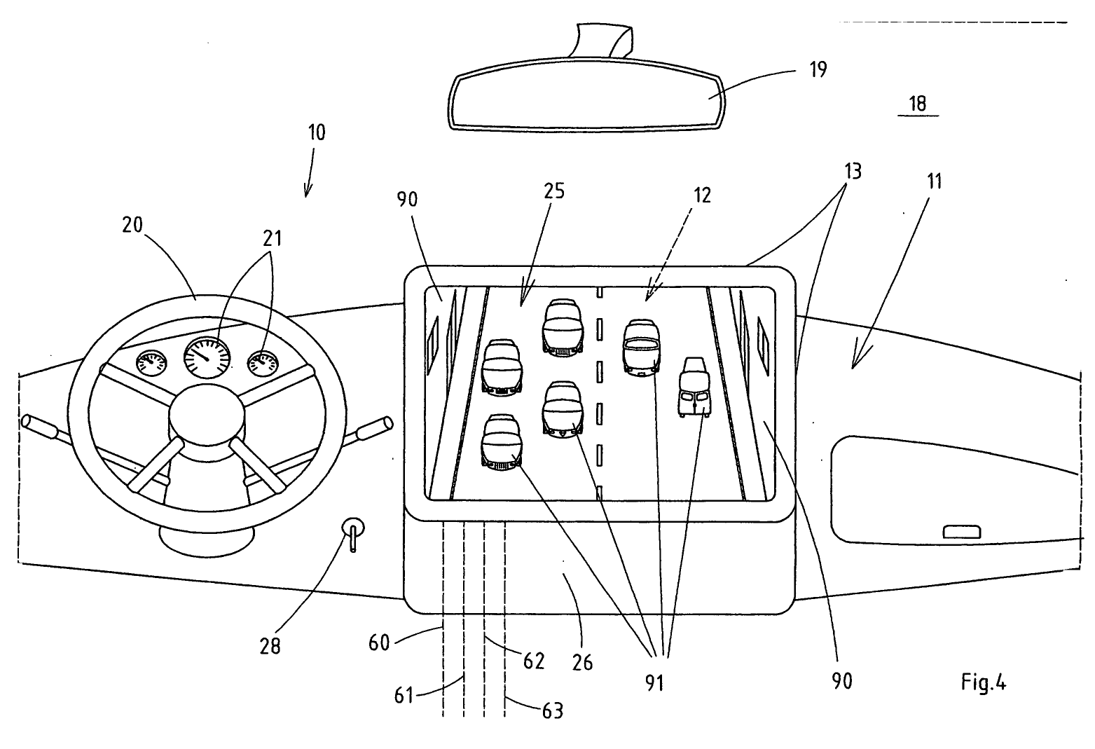

FIG. 4 Front view of the instrument panel inside the vehicle.

The standard motor vehicle 10 presents a large-size rectangular kinescope 25, with its electronics 26, in a central position 12 on the instrument panel 11.

At the position of the kinescope the panel extends upward 13, but leaves clear the lower limit 71 of the optic cone 70 (FIG. 1) which, from the eyes 51 of the driver 50, passes over the top 15 of the bonnet 14.

As seen in the detail in FIG. 2, each device with iconoscope, such as 30, has an objective 41, an iconoscope 42, electronic parts 43, and is housed in a recess fitted with a door flap 45. The electronics 26 of the kinescope 25 convert the electric signals from the electronics 43 (FIG. 2, detail) of the devices 30 and 31 with iconoscope, mounted respectively on the rear of the motor vehicle 10, and of the devices 32 and 33 with iconoscope respectively mounted higher up on the sides of the vehicle.

The electronics 43 of the various devices 42 with iconoscope 30-33, are connected to the electronics 26 of the kinescope 25 by electric wiring 60-63 respectively (FIG. 2).

On starting up the vehicle, the door flaps 45 open automatically and the objectives 41 partially emerge to assume the best operative position.

FIGS. 1 and 2 show the vehicle ready to move off with the door flaps 45 open.

FIG. 3 shows the vehicle when idle with the door flaps 45 closed.

FIG. 4 also shows the windshield 18 with an ordinary driving mirror 19, the steering wheel 20 and usual indicator levers 21 beside the kinescope.

The electronics 26 of kinescope 25 fulfil two essential functions:
conversion of electric signals to luminous signals to produce the images on the screen of the kinoscope;
process control of the four images received from the iconoscopes 42 to avoid interference or superimposition and to compose an image on the screen of the kinoscope showing the space behind the moving motor vehicle as close to reality as possible.

In this situation the driver 50 can benefit, from one moment to the next, both of a direct view of the space in front, symbolically indicated by the optic cone 70 (FIG. 1), and also an electronic image of the space behind, symbolically indicated by the optic cone 72, created by composition of the optic cones 80-83 corresponding to the images from the four devices with iconoscope 30-33.

Roadside buildings 90 and the cars 91 following the vehicle 10, can be seen on the screen of the kinescope 25 (FIG. 4)

When reversing the vehicle the driver will mainly use these electronic images.

The kinescope is also used for a system of navigation by satellite, easy to insert by means of a switch 28 on the instrument panel.

1. Apparatus (25, 26, 28, 30-33, 41-43, 60-63) for electronic rearward vision in motor vehicles (10),
characterized in that it comprises a kinescope (25) placed centrally on the instrument panel (11), and device with iconoscope (30-33), placed laterally and facing towards the rear of the motor vehicle (10), and on the rear itself, so situated as substantially to form lateral and rearward “eyes” for the driver (50) so that, during forward movement, without turning his head and shoulders, he not only keeps a continuous watch on the space in front but also, observing the kinescope (25), can view the whole area surrounding the vehicle (10) and therefore note changes in the space available, caused both by movement of his own vehicle as well as by that of other vehicles and, when reversing the vehicle, be able to see how much space is available at the side as well as in front, of particular advantage when parking.

2. Apparatus (25,26, 28, 30-33, 41-43, 60-63) for electronic rearward vision in motor vehicles (10) as in claim 1, characterized in that the device with iconoscope (32, 33) is placed on the sides of the motor vehicle (10) towards the rear.

3. Apparatus (25,26, 28, 30-33, 41-43, 60-63) for electronic rearward vision in motor vehicles (10) as in claim 1, characterized in that there is one device with iconoscope (32,33) for each side of the vehicle.

4. Apparatus (25,26, 28, 30-33, 41-43, 60-63) for electronic rearward vision in motor vehicles (10) as in claim 1, characterized in that there are two devices with iconoscope (32,33) for each side of the vehicle, and two (30, 31) on the rear.

5. Apparatus (25,26, 28, 30-33, 41-43, 60-63) for electronic rearward vision in motor vehicles (10) as in claim 1, characterized in that each device (30-33) comprises an objective (41), an iconoscope (42), and the electronic system (43).

6. Apparatus (25,26, 28, 30-33, 41-43, 60-63) for electronic rearward vision in motor vehicles (10), as in claim 5, characterized in that the objective (41) is wide-angled.

7. Apparatus (25,26, 28, 30-33, 41-43, 60-63) for electronic rearward vision in motor vehicles (10) as in claim 1, characterized in that the kinoscope (25) with related electronics (26) and the other electronic components including those for the various devices with iconoscope (30-33), such as power feed, are placed on the instrument panel (11).

8. Apparatus (25,26, 28, 30-33, 41-43, 60-63) for electronic rearward vision in motor vehicles (10), as in claim 1,
characterized in that the kinescope (25) is situated centrally on the instrument panel (11), partially extending as far as the bottom of the windshield (18) but without reaching the lower limit of the optic cone (70) projecting from the eyes (51) of the driver (50) forward of the vehicle (10) keeping in line with the top (15) of the bonnet (14).

9. Apparatus (25,26, 28, 30-33, 41-43, 60-63) for electronic rearward vision in motor vehicles (10) as in claims 1 and 7,
characterized in that the devices with iconoscope (30-33) are placed so as to transmit a substantially panoramic view (70, 72) to the electronic system (26) of the kinoscope (25), to show the space at the sides and rear of the motor vehicle (10).

10. Apparatus (25, 26, 28, 30-33, 41-43, 60-63) for electronic rearward vision in motor vehicles (10), as in claims 6 and 7,
characterized in that the electronic system (26) of the kinoscope (25) for reconversion of electric signals sent out by the electronics (43) in the devices with iconoscope (30-33), into pictures, comprises a process control computer to provide an overall view of space at the side and back of the vehicle, correcting any superimposition, interruption and other irregularities as and when they occur.

11. Apparatus (25, 26 28, 30-33, 41-43, 60-63) for electronic rearward vision in motor vehicles (10) as in claims 1 and 10,
characterized in that the process control computer corrects deflection in images caused by the fact that the kinoscope (25) faces the same way as the objectives (41).

12. Apparatus (25, 26, 28, 30-33, 41-43, 60-63) for electronic rearward vision in motor vehicles (10) as in claim 1,
characterized in that the device with iconoscope (30-33) is protectively housed in a recess closed by a door flap (45), there being motor-driven means that automatically open said door flap (45), when the vehicle is started, permitting said device with iconoscope (30-33) to assume its correct operative position.

13. Apparatus (25, 26, 28, 30-33, 41-43, 60-63) for electronic rearward vision in motor vehicles (10) as in claim 1,
characterized in that the kinescope (25) can also serve for navigation by satellite, using the control (28) for the purpose.

14. Apparatus (25, 26, 28, 30-33, 41-43, 60-33) for electronic rearward vision in motor vehicles (10) as in claim 1,
characterized in that the kinescope (25) can also serve to provide the driver with any other useful indications.
